(19) United States
(12) Patent Application Publication
(10) Pub. No.: US 2026/0243330 A1
(43) Pub. Date: Aug. 20, 2026

(54) LUBRICANT DISTRIBUTION DEVICE FOR ATTACHMENT TO A PLANET CARRIER AND PLANETARY GEAR SET WITH SUCH A LUBRICANT DISTRIBUTION DEVICE

(71) Applicant: ZF Friedrichshafen AG, Friedrichshafen (DE)

(72) Inventors: Wolfgang HÜBLER, Wolpertswende (DE); Sylva ROTHER, Kressbronn am Bodensee (DE); Mario HOLDER, Tettnang (DE); Hermann LANZ, Frickingen (DE); Berthold SCHRAFF, Friedrichshafen (DE); Horst LEICHSENRING, Meinheim (DE); Frank SAUTER, Meckenbeuren (DE)

(73) Assignee: ZF Friedrichshafen AG, Friedrichshafen (DE)

(21) Appl. No.: 19/541,990

(22) Filed: Feb. 17, 2026

(30) Foreign Application Priority Data
Feb. 17, 2025 (DE) 10 2025 105 755.9

(51) Int. Cl. F16H 3/66; F16H 1/28; F16H 57/04

(52) U.S. Cl. CPC F16H 3/66; F16H 1/28; F16H 57/043; F16H 57/0479; F16H 57/0482; F16H 57/0486; F16H 2200/2007

(57) ABSTRACT

A lubricant distribution device (10) for attachment to a planet carrier (23) of a planetary gearset (20) has a first annular disk (1) with fastening elements (3) arranged to enable axial attachment to the planet carrier (23), and a second annular disk (2) arranged coaxially with and connected to the first annular disk (1). Pockets (4) are defined between the two annular disks (1, 2) and have pocket inlet openings (5) on an inner circumference of the lubricant distribution device (10) to capture lubricant injected onto the inner circumference. The pockets (4) also have guide vanes (6, 7) between the two annular disks (1, 2) and in each case a pocket outlet opening (8), so that the lubricant injected onto the inner circumference is conveyed to the pocket outlet opening (8), where the pocket outlet openings (8) are circumferentially offset relative to the pocket inlet openings (5).

### RELATED APPLICATIONS

This application claims the benefit of and right of priority under 35 U.S.C. § 119 to German Patent Application no. 10 2025 105 755.9, filed on 17 Feb. 2025, the contents of which are incorporated herein by reference in its entirety.

### FIELD OF THE DISCLOSURE

The invention relates to a lubricant distribution device for attachment to a planet carrier of a planetary gear set. In addition, the invention relates to a planetary gear set comprising a rotatable sun gear shaft, a rotatable ring gear shaft, an immobilized planet carrier with a plurality of planetary gearwheels arranged rotatably on planetary gearwheel bolts on the planet carrier, and a lubricant distribution device of such a type. The lubricant distribution device is provided for cooling and/or lubricating the planetary gear set, in particular the planetary gearwheels.

### BACKGROUND

For example, DE 10 2021 209 883 A1 discloses a lubricant distribution device for attachment to a planet carrier of a planetary gear set, which comprises a rotating guide section which is provided, when the lubricant distribution device is fixed to the planet carrier, to convey lubricant flowing radially from inside onto the guide section in the direction of the planet carrier. The guide section is connected to a rotating web, which projects axially relative to the guide section on one side where the lubricant distribution device is to be attached to the planet carrier, such that at a periphery the web forms a contact surface for contact with the planet carrier. In at least one transition zone of the axially projecting web, stiffening ribs are provided, which are distributed around the circumference in the guide section.

### SUMMARY

The purpose of the present invention is to provide an alternative lubricant distribution device. In particular the lubricant distribution device should be suitable for attachment to an immobilized planet carrier while at the same time enabling efficient lubrication and cooling of the planet carrier. Such a planet carrier does not rotate during operation so that the planet carrier itself cannot exert any centrifugal forces on the lubricant distribution device and the lubricant it is distributing.

That objective is achieved by a lubricant distribution device as disclosed herein. Advantageous embodiments will be apparent from the description given below and the figures.

According to a first aspect, a lubricant distribution device for attachment to an immobilized planet carrier of a planetary gear set is provided, which comprises a first annular disk with a plurality of fastening elements arranged on it to enable axial attachment to the planet carrier, and a second annular disk arranged coaxially with the first annular disk and connected to the latter.

Between the two annular disks are formed a plurality of pockets. The pockets have pocket inlet openings around an inner circumference of the lubricant distribution device. These pocket inlet openings are designed to capture lubricant injected onto the inner circumference of the lubricant distribution device. The pockets also have guide vanes between the two annular disks, and in each case a pocket outlet opening. In particular, the pocket outlet openings are arranged radially outside relative to the pocket inlet openings. The guide vanes of the pockets are shaped such that they guide lubricant injected onto the inner circumference toward the pocket outlet openings. In the circumferential direction of the lubricant distribution device, the pocket outlet openings are arranged offset relative to the pocket inlet openings.

Thus, the lubricant distribution device comprises two annular disks connected to one another and thereby forming a number of pockets for capturing and distributing lubricant such that the lubricant is conveyed though the pocket inlet openings into the respective pockets and emerges from the pockets through the respective pocket outlet openings. The pocket inlet openings are formed by the two annular disks, which are at least partially axially in contact with one another. The pocket outlet openings are preferably formed only in the first annular disk.

An annular disk is understood to be a flat annular element, which can have depressions, elevations, and cut-outs. The two annular disks have an inner circumference and an outer circumference. A pocket is understood to be a space formed between the two annular disks. The pocket is provided in order to capture and distribute lubricant. Preferably, each pocket has just one pocket inlet opening and just one pocket outlet opening. In particular, for each planetary gearwheel bolt of the planet carrier, just one of the pockets is provided, which is designed to capture lubricant and guide it into a central bore in the planetary gearwheel bolt concerned. The lubricant is injected out of essentially radially extending openings in a rotating sun gear shaft of the planetary gear set.

The planet carrier and the lubricant distribution device connected thereto are immobilized and thus prevented from rotating. It is only the rotation of the sun gear shaft and the resulting kinetic energy of the lubricant ejected from the sun gear shaft which are used for filling the pockets of the lubricant distribution device and for conveying the lubricant by means of guide vanes into the planetary gearwheel bolts.

In an embodiment, the pocket inlet openings are slot-shaped and extend in the circumferential direction of the lubricant distribution device between the two annular disks. Preferably, the pocket outlet openings are in the form of axial perforations, for example bores in the first annular disk. Preferably, each pocket tapers at least partially from its pocket inlet opening toward its pocket outlet opening.

Preferably, the number of pocket inlet openings is the same as the number of pocket outlet openings and the number of planetary gearwheel bolts. The pocket inlet openings are preferably arranged adjacent to one another in the circumferential direction and are separated only by the guide vanes. In that way a large capture surface for the ejected lubricant is provided. In particular, each pocket is tapered in the radial direction in such manner that the lubricant injected into it is led into the respective pocket outlet opening, which is positioned offset in the circumferential direction in the first annular disk relative to the corresponding pocket inlet opening.

Preferably the guide vanes form walls of the pockets. In that way, not only material but also weight can be saved, so that the lubricant distribution device is improved still more. In particular, each pocket has just two guide vanes. In particular, the pocket is delimited by the two guide vanes in the circumferential direction. Preferably, the guide vanes are in the form of elevations, particularly ribs, in the first and/or the second annular disk. In that way they can be produced simply as part of the annular disk concerned.

Preferably, the guide vanes are formed monolithically on the first annular disk and come into fluidic contact at their ends with the second annular disk so as to form the pockets. Alternatively, the guide vanes are formed monolithically on the second annular disk and come into fluidic contact at their ends with the first annular disk so as to form the pockets.

The two annular disks are preferably made from a temperature and oil-resistant plastic or a fiber composite material, in particular from a glass-fiber-reinforced plastic. For example, the two annular disks are made from polyamide or polyphthalamide. In particular the two annular disks are connected to one another in a material-merged manner, for example by adhesive bonding or by welding. In this case the bonding or welding is carried out in particular along the guide vanes in order to ensure that the pockets are leak-proof between the two annular disks.

Preferably, one of the two annular disks is made transparent so that the guide vanes of the annular disk coming into contact with it can be seen and can be welded by laser from the outside. This improves the assembly of the lubricant distribution device.

In an embodiment, at least a first guide vane of each pocket is at least partially curved and at least a second guide vane of the pocket concerned is made straight. For example, each pocket has just two guide vanes, namely one curved (first) guide vane and one straight (second) guide vane. In particular, the curved guide vane of the pocket concerned is bow-shaped and longer than the straight guide vane of that pocket. Preferably, all the pockets of the lubricant distribution device are identically formed. Each guide vane extends from the inner circumference of the lubricant distribution device to the outer circumference of the lubricant distribution device, and in the area of the outer circumference the corresponding pocket outlet opening is formed in the first annular disk.

In an embodiment, a collar is formed on each pocket outlet opening, which is designed to project axially at least partially into a respective planetary gearwheel bolt held on the planet carrier. The collar is made surrounding the pocket outlet opening and serves as a plug element or support in order to connect the pocket outlet opening in a leak-proof manner to a central bore of the planetary gearwheel bolt. The collar has an outer diameter which corresponds essentially with the inside diameter of the central bore of the planetary gearwheel bolt. Preferably, on an outer circumference the collar is chamfered so as to simplify the fitting of the lubricant distribution device onto the planetary gearwheel bolts, since the chamfer facilitates the entry of the respective collar into its corresponding central bore of a planetary gearwheel bolt.

In an embodiment, at least one fastening element is arranged axially on the first annular disk, which is designed to snap-fit into a recess provided for the purpose in the planet carrier. For example, the fastening element is formed on the front side of the first annular disk and in the assembled condition it projects into the planet carrier. Preferably, exactly three or at least three such fastening elements are provided. Preferably, the fastening elements are arranged distributed uniformly in the circumferential direction around the lubricant distribution device.

In an embodiment, each fastening element has one or more elastically deformable snap-fitting tongues with an undercut contour. Thereby, the lubricant distribution device can be fixed to the planet carrier. The snap-fitting tongues deform elastically radially inward when inserted into the cut-outs in the planet carrier and snap radially outward when they project beyond the opposite side of the cut-out, so having an axial securing action. A snap-fitting tongue is understood to be an element similar to a holding clip. For example, a plurality of snap-fitting tongues, in particular at least three of them, form a fastening element.

According to a second aspect, a planetary gear set is provided, which comprises a rotatable sun gear shaft, a rotatable ring gear shaft, an immobilized planet carrier with a plurality of planetary gearwheels arranged rotatably on planetary gearwheel bolts on the planet carrier, and a lubricant distribution device according to the first aspect. The lubricant distribution device is attached to the planet carrier, specifically fixed axially onto it. The sun gear shaft has one or more openings, in particular bores, for lubricant to pass through to an outer circumference of the sun gear shaft. In this case the lubricant distribution device is arranged with an inner circumference on the outer circumference of the sun gear shaft and is designed to capture lubricant ejected out of the opening or openings of the sun gear shaft and pass it into the planetary gearwheel bolts.

In particular, the planetary gear set is part of a transmission for a motor vehicle. The sun gear shaft is preferably provided as the drive input shaft of the planetary gear set in order to feed in a drive-power, preferably from an electric machine. The ring gear shaft is then provided as the drive output shaft of the planetary gear set and is connected, at least indirectly, for example by way of a ring gear carrier, to a drive output shaft of the transmission or to further transmission stages. The planetary gearwheels mesh with the sun gear shaft and with the ring gear shaft. The planet carrier, which carries the planetary gearwheels on planetary gearwheel bolts, is immobile, specifically since the planet carrier is connected to a housing or to a component fixed to the housing. The planetary gearwheels are mounted rotatably on the planetary gearwheel bolts.

The openings in the sun gear shaft are in particular in the form of radial bores and convey lubricant from inside the sun gear shaft to the outer circumference of the sun gear shaft. In particular, several or all the openings are arranged on the sun gear shaft distributed uniformly in the circumferential direction. Due to the rotation of the sun gear shaft, the lubricant is ejected from the openings and the faster the sun gear shaft rotates, the larger is the centrifugal force acting upon the lubricant and thus also the speed of the ejected lubricant.

The lubricant distribution device is arranged with the pocket inlet openings on the outer circumference of the sun gear shaft in such manner that the lubricant ejected from the openings of the sun gear shaft is injected directly into the pockets of the lubricant distribution device and is deflected by the guide vanes to the corresponding pocket outlet openings, which are arranged offset in the circumferential direction relative to the pocket inlet openings. Each pocket outlet opening is fluidically connected to a central bore in a corresponding planetary gearwheel bolt, so that the captured lubricant passes on to the planetary gearwheels through the planetary gearwheel bolts.

In particular, a plurality of apertures, such as radial bores distributed around the circumference, are arranged in each planetary gearwheel bolt, so that by virtue of gravity the lubricant seeks to flow down and out of the central bore of the planetary gearwheel bolt concerned. In that way, the mountings of the planetary gearwheels and the tooth engagement area between each planetary gearwheel, the sun gear shaft and the ring gear shaft is lubricated and cooled efficiently. Further, means for conveying lubricant into the static planetary gearwheel bolts are not needed. This saves assembly cost and effort as well as weight, material and fitting space.

According to a third aspect, a motor vehicle with a planetary gear set according to the second aspect is provided. The above definitions and statements about technical effects advantages and advantageous embodiments of the lubricant distribution device according to the invention also apply analogously to the planetary gear set according to the invention and the motor vehicle according to the invention. Preferably, the motor vehicle is an electric or hybrid motor vehicle.

### BRIEF DESCRIPTION OF THE DRAWINGS

Advantageous embodiments of the invention, which are explained below, are illustrated in the drawings, in which the same or similar elements are denoted by the same indexes, and which show:

FIG. 1: A schematic and perspective representation of a lubricant distribution device with a first annular disk and a second annular disk,

FIG. 2: A schematic and perspective representation of the second annular disk shown in FIG. 1,

FIG. 3: A schematic view from above, of the second annular disk shown in FIGS. 1 and 2,

FIG. 4: A schematic, sectioned representation of part of a transmission with a planetary gear set and the lubricant distribution device according to FIG. 1,

FIG. 5: A schematic, sectioned representation in detail, of part of the planetary gear set shown in FIG. 4, and

FIG. 6: A schematic, sectioned representation in detail, of part of the planetary gear set shown in FIG. 5.

### DETAILED DESCRIPTION

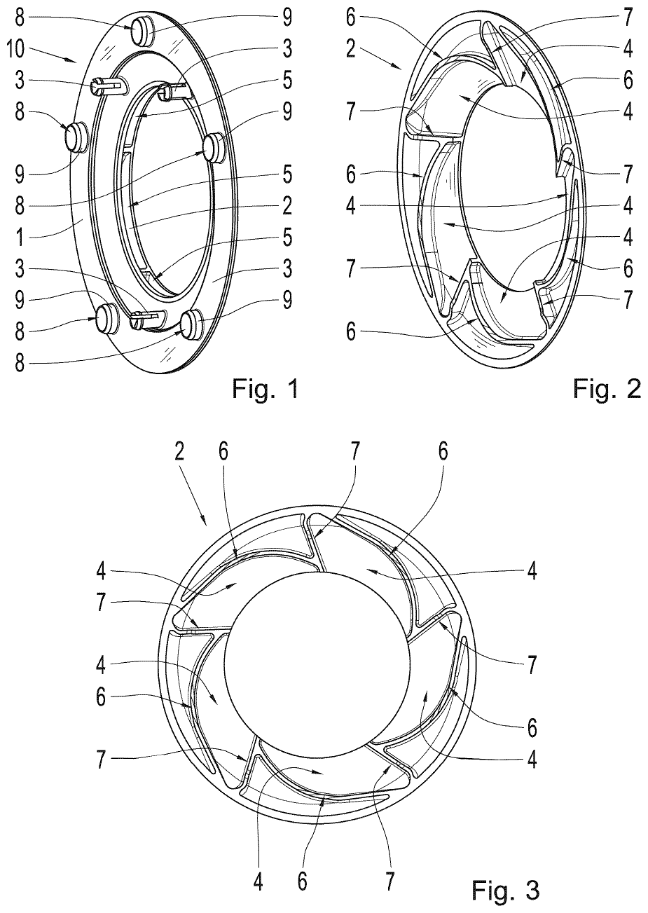

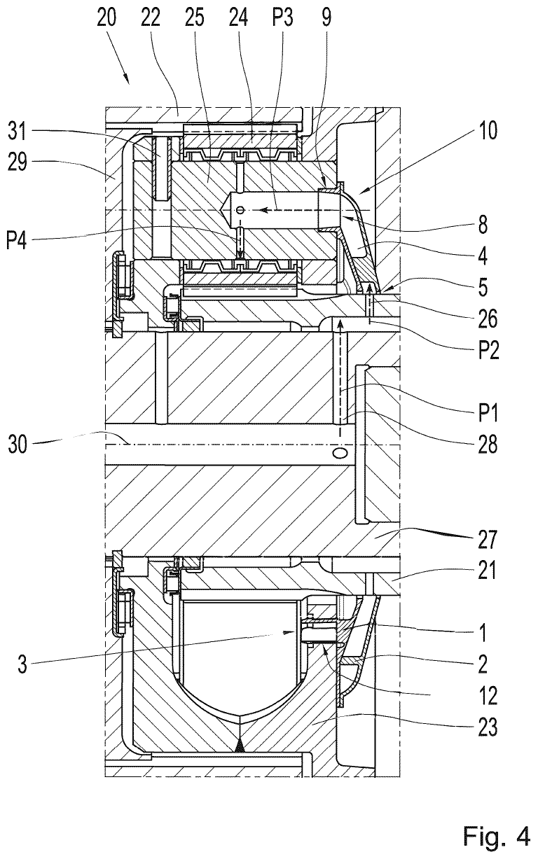

FIG. 1 shows a lubricant distribution device 10 for fastening to a planet carrier 23 of a planetary gear set 20 shown in FIG. 4. The lubricant distribution device 10 consists of a first annular disk 1 and a second annular disk 2, which are permanently connected to one another, in particular with interlock or by a material-merging method. The two annular disks 1, 2 are arranged coaxially with one another and form, spatially between them, a number of pockets 4 for capturing lubricant and passing it on, which pockets are shown in FIGS. 2 and 3. The lubricant, which for example is an emulsion or an oil or oil mixture, makes its way via a respective pocket inlet opening 5 to an inside circumference of the lubricant distribution device 10 in the pocket 4 concerned, between the two annular disks 1, 2. The lubricant is then conveyed by guide vanes 6, 7, which are also shown in FIGS. 2 and 3, between the two annular disks 1, 2 to a respective pocket outlet opening 8 in the first annular disk 1.

The essentially closed structure of the lubricant distribution device 10 prevents the captured lubricant from flowing back into the lubricant sump and enables effective lubricant guiding.

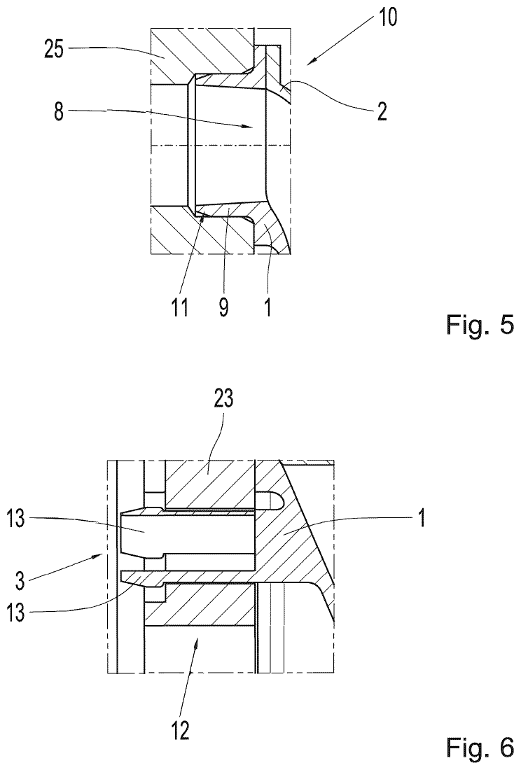

On each pocket outlet opening 8 is formed an all-round collar 9, which is designed to project axially at least partially into a planetary gearwheel bolt 25 held on the planet carrier 23, as can be seen particularly clearly in FIGS. 4 and 5. Furthermore, one or more fastening elements 3 can be arranged axially on the first annular disk 1, which are designed to snap into cut-outs 12 provided for the purpose in the planet carrier 23, as can be seen particularly clearly in FIGS. 4 and 6, in order to fix the lubricant distribution device onto the planet carrier 23.

In this case, the lubricant distribution device 10 has, for example, five pocket inlet openings 5 and five pocket outlet openings 8, such that each respective inlet opening 5 is fluidically connected via the pocket 4 concerned to the corresponding pocket outlet opening 8. The pockets 4 are not fluidically connected to one another, but rather, separated from one another by the guide vanes 6, 7.

The lubricant injected into each pocket 4 is conveyed by the respective guide vane 6, 7 between the two annular disks 1, 2 to the corresponding pocket outlet opening 8 in the first annular disk 1. The pocket outlet openings 8 are arranged offset relative to the pocket inlet openings 5 in the circumferential direction of the lubricant distribution device 10.

The guide vanes 6, 7 are formed by the walls of the pockets 4 and are preferably in the form of elevations in the second annular disk 2, as can be seen particularly clearly in FIGS. 2 and 3. The pocket inlet openings 5 are slot-shaped and extend in the circumferential direction between the two annular disks 1, 2. The pocket outlet openings 8 are in the form of axial perforations in the first annular disk 1.

As is shown clearly in FIGS. 2 and 3, the guide vanes 6, 7 are preferably formed monolithically on the second annular disk 2 and are designed to make contact at their ends (i.e. axially) with the first annular disk 1. Alternatively (not shown here) the guide vanes 6, 7 can be made monolithically with the first annular disk I and they then make contact at their ends with the second annular disk 2

To increase stability and rigidity, the two annular disks 1, 2 also come into contact with one another on an all-round contact surface in the area of the outer circumference. For the fluidic sealing of the respective pockets 4, for example an adhesive is applied to the ends of the guide vanes 6, 7. Thereby the first and second annular disks 1, 2 are connected to one another, and this in such a manner that a tapered area in each pocket 4 is fluidically connected to the corresponding pocket outlet opening 8 in the first annular disk 1. This tapered area is the area in which the two guide vanes 6, 7 of the pocket 4 concerned come together. The pocket 4 tapers from its pocket inlet opening 5 toward its pocket outlet opening 8, wherein a long guide vane 6 of the pocket 4 is essentially curved whereas a shorter guide vane 7 of the pocket 4 is straight.

FIG. 4 shows part of a longitudinal section through a transmission with the planetary gear set 20. The planetary gear set 20 comprises a rotating sun gear shaft 21, a rotating ring gear shaft 22, an immobilized planet carrier 23 with a plurality of planetary gearwheels 24, and the lubricant distribution device 10 according to FIG. 1. The planetary gearwheels 24 are arranged rotatably on planetary gearwheel bolts 25 on the planet carrier 23; in the present case only one planetary gearwheel 25 is shown. The planetary gearwheel bolt 25 is connected rotationally fixed to the planet carrier 23, for example by means of a pin 31.

In this case the sun gear shaft 21 forms the drive input shaft and for that purpose is drivingly connected to a drive machine (not shown), preferably an electric machine. The ring gear shaft 22 is connected rotationally fixed by way of a ring gear carrier 29 to a drive output shaft 27 which forms the central shaft.

The sun gear shaft 21 and the ring gear shaft 22 rotate with different rotation speeds about the common rotation axis 30. The planet carrier 23 is connected rotationally fixed to a housing (not shown) and is therefore prevented from rotating. In other words, the planet carrier 23 is immobilized.

The lubricant distribution device 10 is attached axially to the planet carrier 23, for which purpose the fastening elements 3 (also shown in FIG. 1) snap axially into axial cut-outs 12 provided for the purpose in the planet carrier 23. Furthermore, the collar 9 of the pocket outlet opening 8 projects axially into the planetary gearwheel bolt 25 held on the planet carrier 23. In that way, not only is the introduction of the lubricant into the planetary gearwheel bolt concerned improved, but so also is the stability of the lubricant distribution device 10.

The lubricant is conveyed to the inner circumference of the sun gear shaft 21 through a lubricant duct 28 provided for the purpose, which is formed in the rotating drive output shaft 27 as indicated by the first arrow P1. The sun gear shaft 21 has several radially formed openings 26 for the passage of lubricant to an outer circumference of the sun gear shaft 21. These openings 26 are in particular in the form of bores. As indicated by the second arrow P2, the lubricant is then injected though the openings 26 of the sun gear shaft 21 into the lubricant distribution device 10. For that purpose, the lubricant distribution device 10 is positioned with its inner circumference in the area of the openings 26 of the sun gear shaft 21. The openings 26 in the sun gear shaft 21 are arranged axially between the first and second annular disks 1, 2, so that the lubricant ejected through the openings 26 onto the sun gear shaft 21 passes directly via the pocket inlet openings 5 into the pockets 4 of the lubricant distribution device 10. The lubricant ejected from the sun gear shaft 21 is collected in the pockets 4 and delivered through these into the planetary gearwheel bolts 25, as indicated by a third arrow P3. From the planetary gearwheel bolts 25, as indicated by a fourth arrow P4 the lubricant flow out via radial ducts in the planetary gearwheel bolts 25 and in that way it can efficiently lubricate and cool the mountings of the planetary gearwheels 24 and the tooth engagement zones between the respective planetary gearwheel 24, the sun gear shaft 21, and the ring gear shaft 22.

FIG. 5 represents part of a longitudinal section of the planetary gear set according to FIG. 4, which shows part of a planetary gearwheel bolt 25 and the lubricant distribution device 10. The lubricant distribution device 10, in particular the first and second annular disks 1, 2, are shown in FIG. 5 only in the area of a pocket outlet opening 8. The collar 9 on the pocket outlet opening 8 projects axially into the central bore of the planetary gearwheel bore 25. To simplify the assembly of the lubricant distribution device 10, the collar 9 has a chamfer 11 on an outer circumference. This makes it easier to insert the collar 9 into the central bore of the planetary gearwheel bolt 25, which has essentially the same diameter.

FIG. 6 depicts part of a longitudinal section of the planetary gear set according to FIG. 4, which shows part of the planet carrier 23 and the first annular disk 1. At the focus of FIG. 6 is one of the fastening elements 3, which is arranged axially on the first annular disk 1. In this case each fastening element 3 has several, preferably exactly three elastically deformable snap-tongues 13 with an undercut contour, which are arranged essentially cylindrically. In this case owing to the sectioned representation only two of the three snap-tongues are shown. The snap-tongues engage in the cut-out 12 in the planet carrier 23, so that the first annular disk 1 and the second annular disk connected permanently thereto are fixed to the planet carrier 23.

### INDEXES

1 First annular disk
2 Second annular disk
3 Fastening element
4 Pocket
5 Pocket inlet opening
6 Guide vane
7 Guide vane
8 Pocket outlet opening
9 Collar
10 Lubricant distribution device
11 Chamfer
12 Cut-out 13 Snap-tongue
20 Planetary gear set
21 Sun gear shaft
22 Ring gear shaft
23 Planet carrier
24 Planetary gearwheel
25 Planetary gearwheel bolt
26 Opening
27 Drive output shaft
28 Lubricant duct
29 Ring gear carrier
30 Rotation axis
31 Pin
P1 First arrow
P2 Second arrow
P3 Third arrow
P4 Fourth arrow

1. A lubricant distribution device (10) for attachment to a planet carrier (23) of a planetary gearset (20), comprising:
a first annular disk (1) having a plurality of fastening elements (3) arranged thereon for axial attachment to the planet carrier (23); and
a second annular disk (2) which is arranged coaxially with the first annular disk (1) and which is connected to the first annular disk (1);
wherein a plurality of pockets are defined between the two annular disks (1, 2);
wherein the plurality of pockets (4) has pocket inlet openings (5) on an inner circumference of the lubricant distribution device (10), and configured to capture lubricant which is injected onto the inner circumference; and
wherein the plurality of pockets has guide vanes (6, 7) between the two annular disks (1, 2) and each pocket of the plurality of pockets has a pocket outlet opening (8) arranged so that the lubricant injected onto the inner circumference is conveyed to the pocket outlet opening (8); and
wherein the pocket outlet openings (8) are arranged offset in the circumferential direction relative to the pocket inlet openings (5).

2. The lubricant distribution device (10) according to claim 1,
wherein the pocket inlet openings (5) are slot-shaped and extend in the circumferential direction between the two annular disks (1, 2);
wherein the pocket outlet openings (8) are in the form of axial perforations in the first annular disk (1); and
wherein each pocket (4) tapers at least partially from a respective pocket inlet opening (5) toward a respective pocket outlet opening (8).

3. The lubricant distribution device (10) according to claim 1, wherein the guide vanes (6, 7) are formed by walls of the plurality of pockets (4).

4. The lubricant distribution device (10) according to claim 1, wherein the guide vanes (6, 7) are formed monolithically either on the first annular disk (1) or on the second annular disk (2), and come into fluidic contact at the end with the respective other annular disk (1, 2).

5. The lubricant distribution device (10) according to claim 1, wherein at least a first guide vane (6) of each pocket (4) is formed at least partially curved, and at least a second guide vane (7) of the pocket (4) is straight.

6. The lubricant distribution device (10) according to claim 1, wherein a collar (9) is formed on each pocket outlet opening (8), wherein the collar is configured to project axially at least partially into a planetary gearwheel bolt (25) held on the planet carrier (23).

7. The lubricant distribution device (10) according to claim 6, wherein the collar (9) has a chamfer (11) on an outer circumference in order to facilitate the assembly of the lubricant distribution device (10).

8. The lubricant distribution device (10) according to claim 1, wherein at least one fastening element (3) is arranged axially on the first annular disk (1), the at least one fastening element (3) configured to snap-fit into a cut-out (12) in the planet carrier (23).

9. The lubricant distribution device (10) according to claim 8, wherein the at least one fastening element (3) has one or more elastically deformable snap-tongues (13) with an undercut contour.

10. A planetary gearset (20) comprising:
a rotating sun gear shaft (21),
a rotating ring gear shaft (22),
an immobilized planet carrier (23) with a plurality of planetary gearwheels (24), arranged rotatably on planetary gearwheel bolts (25) on the planet carrier (23), and
the lubricant distribution device (10) according to claim 1 attached to the planet carrier (23), wherein the sun gear shaft (21) has one or more openings (26) for the passage of lubricant to an outer circumference of the sun gear shaft (21);
wherein the lubricant distribution device (10) is arranged with an inner circumference on the outer circumference of the sun gear shaft (21) and is configured to capture lubricant ejected from the opening or openings (26) of the sun gear shaft (21) and convey the lubricant into the planetary gear bolts (25).
